(19) United States
(12) Patent Application Publication
(10) Pub. No.: US 2012/0109520 A1
(43) Pub. Date: May 3, 2012

(54) METHOD FOR PROCESSING AGRICULTURAL DATA

(75) Inventors: Kenneth Brown Hood, Gunnison, MS (US); Hendrik Willem van Riessen, Cleveland, MS (US); William Matthew Peterson, Hernando, MS (US); Patrick Michael Jackson, Memphis, TN (US); Phillip Dewey Gillis, Cleveland, MS (US)

(73) Assignee: InTime, Inc., Cleveland, MS (US)

(21) Appl. No.: 13/285,752

(22) Filed: Oct. 31, 2011

Related U.S. Application Data
(60) Provisional application No. 61/408,435, filed on Oct. 29, 2010.

(51) Int. Cl. G01C 21/26

(52) U.S. Cl. 701/468; 701/408

(57) ABSTRACT

An improved process for collecting, storing, and sending crop data is disclosed. The process allows data to be collected by PDA and uploaded to a server for remote analysis.

### FIELD OF THE INVENTION

The present invention is generally directed toward a device and method for transferring agricultural data from the field to a server for storing, processing and visualization.

### BACKGROUND OF THE INVENTION

Precision farming is a crop management strategy that employs the use of site-specific data to determine the needs of each area of farmland. It allows the farmer to apply only chemicals that are required for each area as opposed to blindly blanketing the soil with chemicals.

Precision agriculture is not a new field, and there exist patents that have been issued for methods and apparatus that can be used in precision farming.

U.S. Pat. No. 6,199,000, issued to Keller et al. describes the use of spatial technology, including GPS, that allows for analysis of seeding, cultivating, planting and harvesting operations.

U.S. Patent Publication 2006/0271262 to McLain describes a camera based farm vehicle monitoring system that allows the operator to monitor multiple farm vehicles to assess crop yield. However, the data that is collected only relates to crop yield and does not measure the application for pesticides or fertilizer.

U.S. Pat. No. 6,195,604 to Moore et al. describes a tractor with a monitoring system that collects GPS data and prepares a yield map showing grain collected in each area, as well as fuel consumption. The information is stored onboard the tractor and does not have the ability to be sent wirelessly for real-time analysis.

U.S. Pat. No. 7,397,392 issued to Mahoney et al. describes a method for providing fleet management information for agricultural machines. The patent is directed toward management of the tractors and does not take readings related to crop production.

U.S. Patent Publication 2006/0155449 filed by Dammann describes a data generation and transmission system in farm machines. However, the data is related to speed of cylinders that are threshing parts and torque on the cylinders. The application is focused on the means for exchanging data, as opposed to a system for collection of data for analysis of crop maintenance.

U.S. Pat. Nos. 5,978,720 and 6,282,476, both to Hieronymus et al. describe combine harvesters with multi-processor units built in. The data collected from the field is stored on a data card in the cabin of the tractor. There is no ability to view real-time data from the field.

### SUMMARY OF THE INVENTION

The currently disclosed invention is a system that allows for real-time collection and transfer of data related to detailed crop production that is sent to a remote server for processing. The data can be viewed through an internet browser or sent back to a mobile device for viewing by the tractor operator.

### BRIEF DESCRIPTION OF THE DRAWINGS

Further advantages of the invention will become apparent by reference to the detailed description of preferred embodiments when considered in conjunction with the drawings:

FIG. 1 depicts the components used for transmitting the results from the tractor cabin to a remote server.

FIG. 2 depicts a PDA that allows tracking of the field conditions.

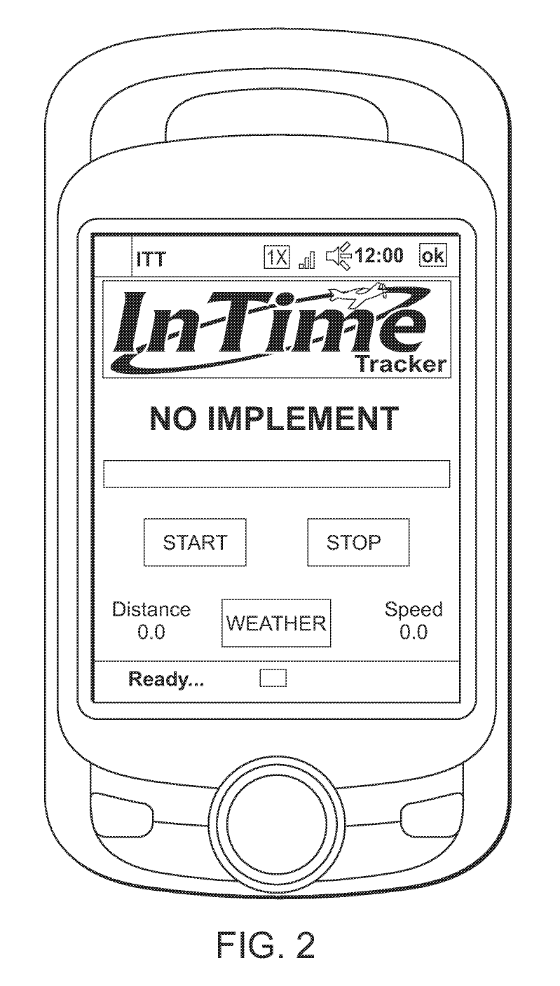

FIG. 3 depicts a screenshot of the web site residing on the server and shows a view of the crop site.

FIG. 4 depicts a sample report generated by the server software.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

The presently disclosed invention is comprised of three parts that are used for the process of sending information wirelessly from the field to a server for processing, displaying to the customer, and making certain information available for third parties.

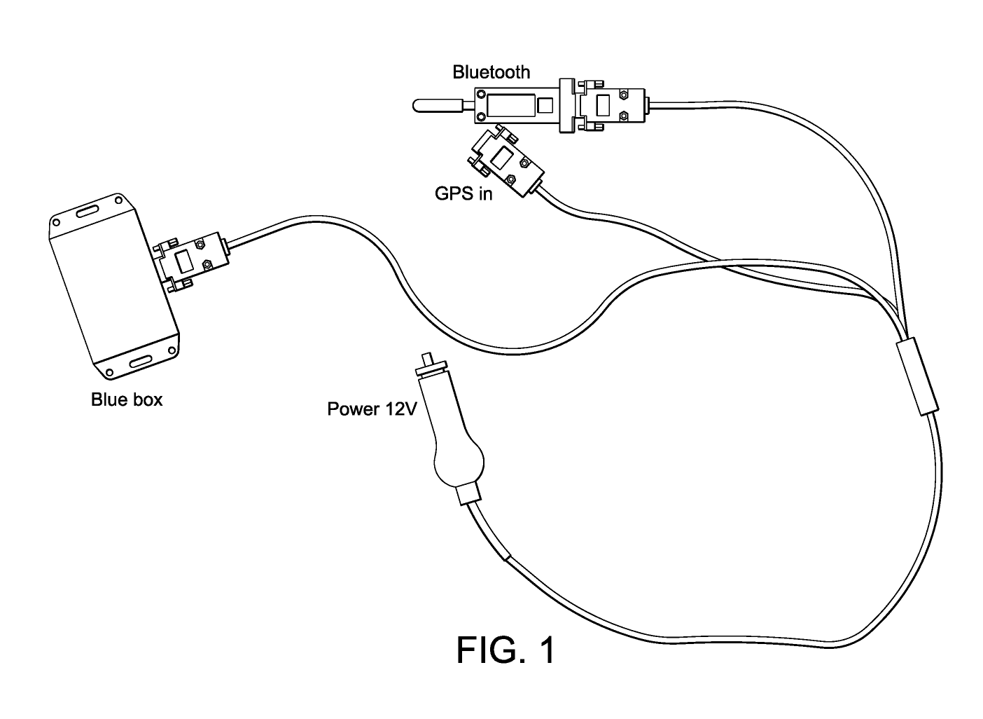

As can be seen from FIG. 1, one part is a ‘Blue box’ or “implementation recognition module” (IRM) which can be attached to an agricultural implement. This component identifies the implement, provides information about it, including various parameters regarding the sensors, and allows for recording from various sensors. The ‘Blue box’ contains a pre-programmed string with information about the implement. For example, the ‘Blue box’ can record the pulses per second from a flow meter and the on/off position of the boom sections on a sprayer. The ‘Blue box’ is connected to a GPS unit which supplies a GGA- and VTG-string once per second. These strings are passed on unmodified. The stored string and the collected data can be retrieved by sending a special command to the box through a generic serial connection or via Bluetooth and other known communication technologies.

In a first embodiment, the ‘Blue box’ has fifty programmable fields, and the ‘Blue box’ is small enough to be mounted on most toolbars, without interfering with the functionality of the implement to which it is mounted. The ‘Blue box’ includes mounting tabs that will allow for easy, secure installation and will be powered by 12DC volts. The ‘Blue box’ can respond to a command initiated by a PDA or tablet PC running software program. The response string is in comma delimited format and contains 50 different programmable fields. The values of each field are listed below. Fields not used for a particular implement are represented in the string by a null value.

| Programmable | |
|---|---|
| Field | Variable |
| 1 | Unique Number |
| 2 | Type of Box - 01 for IRM |
| 3 | Type of Implement |
| 4 | Brand of Implement |
| 5 | Model # of implement |
| 6 | Overall width of implement |
| 7 | Dry or Liquid |
| 8 | Flow meter calibration number or encoder calibration |
| | number |
| 9 | Number of sections |
| 10 | Tank Size (in gallons) or Hopper size (in tons) |
| 11 | Section 1 width (in inches) |
| 12 | Section 1 distance from center (in inches) |
| 13 | Section 1 Fore/Aft distance from GPS (in inches) |
| 14 | Section 2 width (in inches) |
| 15 | Section 2 distance from center (in inches) |
| 16 | Section 2 Fore/Aft distance from GPS (in inches) |
| 17 | Section 3 width (in inches) |
| 18 | Section 3 distance from center (in inches) |
| 19 | Section 3 Fore/Aft distance from GPS (in inches) |
| 20 | Section 4 width (in inches) |
| 21 | Section 4 distance from center (in inches) |
| 22 | Section 4 Fore/Aft distance from GPS (in inches) |
| 23 | Section 5 width (in inches) |
| 24 | Section 5 distance from center (in inches) |
| 25 | Section 5 Fore/Aft distance from GPS (in inches) |
| 26 | Section 6 width (in inches) |
| 27 | Section 6 distance from center (in inches) |
| 28 | Section 6 Fore/Aft distance from GPS (in inches) |
| 29 | Section 7 width (in inches) |
| 30 | Section 7 distance from center (in inches) |
| 31 | Section 7 Fore/Aft distance from GPS (in inches) |
| 32 | Section 8 width (in inches) |
| 33 | Section 8 distance from center (in inches) |
| 34 | Section 8 Fore/Aft distance from GPS (in inches) |
| 35 | Section 9 width (in inches) |
| 36 | Section 9 distance from center (in inches) |
| 37 | Section 9 Fore/Aft distance from GPS (in inches) |
| 38 | Section 10 width (in inches) |
| 39 | Section 10 distance from center (in inches) |
| 40 | Section 10 Fore/Aft distance from GPS (in inches) |
| 41 | Unused |
| 42 | Unused |
| 43 | Unused |
| 44 | Unused |
| 45 | Unused |
| 46 | Unused |
| 47 | Unused |
| 48 | Unused |
| 49 | Unused |
| 50 | Unused |

The second part of the disclosed invention is the software called InTime Tracker (ITT) which runs on a PDA cell phone or on a laptop with a wireless card. This program collects the data (GPS, preprogrammed information, and flow/boom data) from the ‘Blue box’ through a generic serial-to-Bluetooth connection or a standard serial-to-USB cable. It should be appreciated that the Bluetooth connection allows different PDAs, laptops, or smartphones to be used, and for the PDA to be conveniently located with the operator.

The software enables collection of the data, and, upon pressing the ‘Stop’ button, the software will store the file locally and send it wirelessly to the InTime server, as further described in Paragraph [0022]. If the file cannot be sent to the server due to loss of connectivity, it will log the file as “not sent.” The software will attempt to send the file next time ITT is being stopped or when the user manually requests to send the remaining files. In addition, the software can send an alert, such as E-mails and/or SMS-message, when the program is started, stopped, or when the vehicle is sitting idle for a predefined number of minutes. If the alert cannot be sent immediately, it will be sent as soon as a file or an alert is being sent.

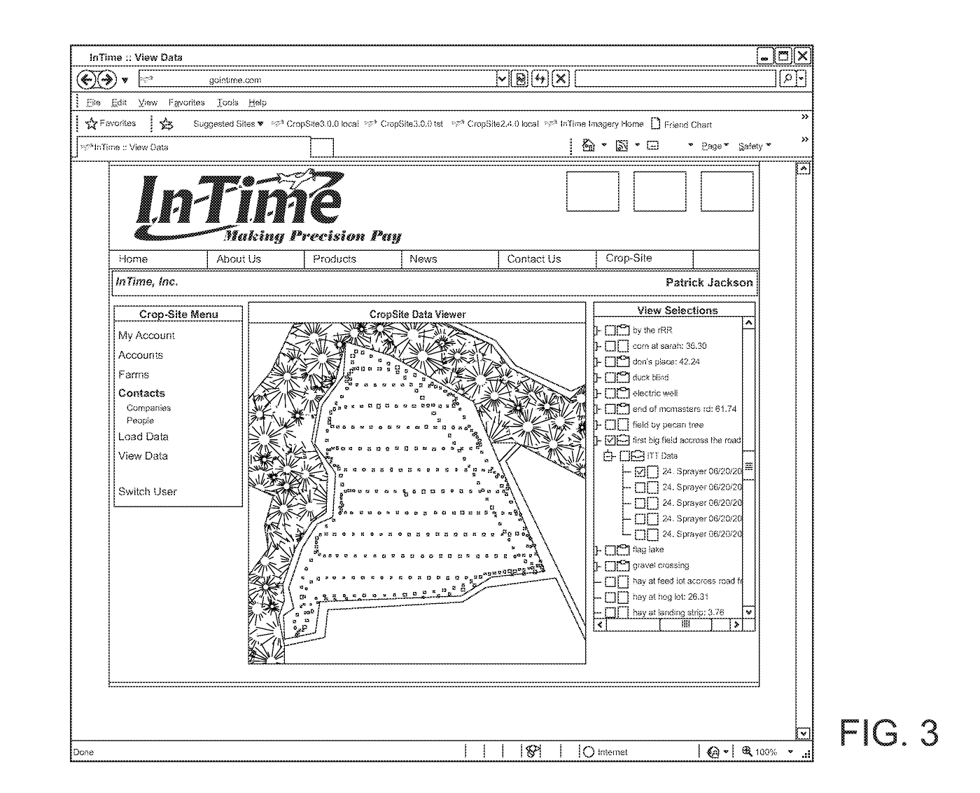

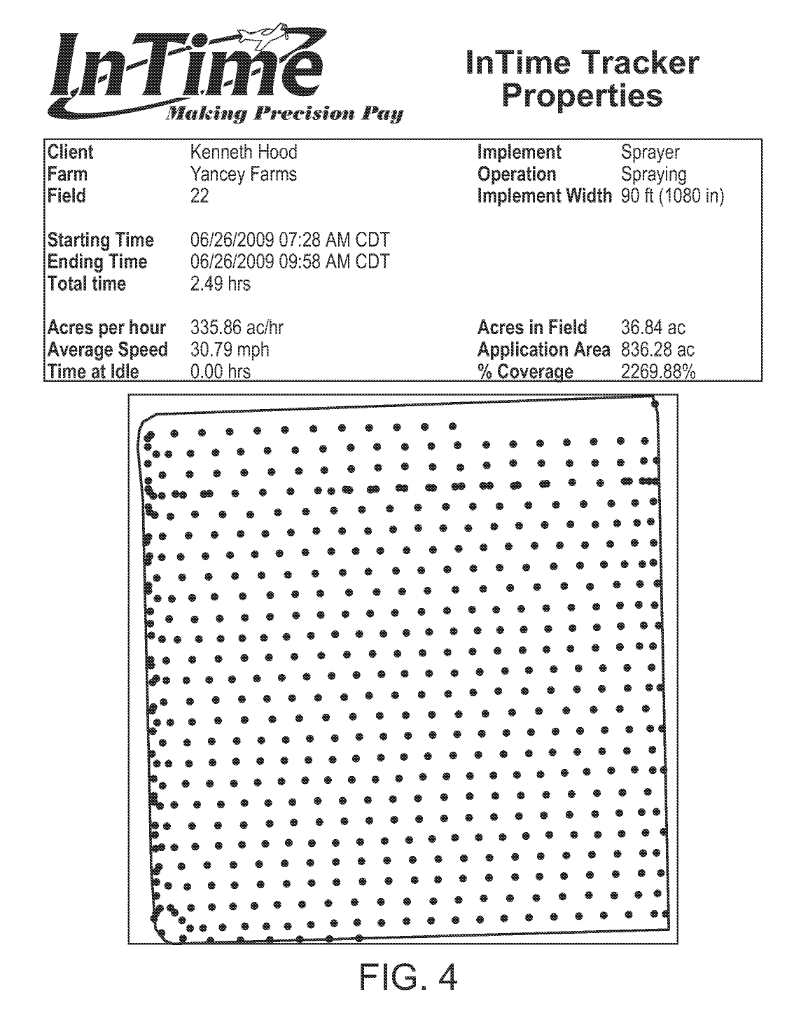

The third component of the disclosed invention is the software which resides on the InTime server. A screenshot of the server software can be seen in FIG. 3. This server software runs continuously and collects the data from the ITT program as soon as it is sent by the ITT program. The server software will compare the spatial information of the ITT data with the spatial information of the fields (boundaries) of the client that is linked to the device sending the data. If the spatial information is linked to a field, the data is stored as field data. If the spatial data is not linked to any fields, the data is stored in a separate ‘collection bin.’ If no client is linked to the device sending the ITT data, the data is stored in a separate ‘collection bin.’ These collection bins are checked whenever new boundaries are loaded for a client. The client can view the data as soon as it is linked to a field. The displayed information can include the time spent in a field, the path driven in the field, the actual acres worked in the field, etc. A report of the field data can then be printed, a sample of which can be seen in FIG. 4. In addition to processing and visualization (on InTime's website through Crop-Site) of the data, the software allows remote retrieval of information by third parties.

As disclosed in the first embodiment, the system collects positional and yield data. It should be appreciated that it can be used on VERIS rigs, soil sample rigs, or any application that needs information recorded, processed or displayed. It should further be appreciated that it allows bi-directional transfer of information so that a user of the website can send feedback to the cabin of the tractor.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

We claim:

1. A method for recording agricultural data and sending it to a server for processing, reporting, and displaying on a website.

2. The method of claim 1 wherein said data is from a boom mounted on a tractor.

3. The method of claim 1 wherein said data can be viewed on a PDA prior to sending.

4. The method of claim 1 wherein data is automatically associated with a client based on the GPS coordinates.
